(19) United States
(12) Patent Application Publication
(10) Pub. No.: US 2020/0167553 A1
(43) Pub. Date: May 28, 2020

(54) METHOD, SYSTEM AND APPARATUS FOR GESTURE RECOGNITION

(71) Applicant: SAGE SENSES INC., Toronto (CA)

(72) Inventors: Arash ABGHARI, Kitchener (CA); Sergiu GIURGIU, Kitchener (CA)

(21) Appl. No.: 16/631,665

(22) PCT Filed: Jul. 19, 2018
(86) PCT No.: PCT/IB2018/055402

§ 371 Date: Jan. 16, 2020

Related U.S. Application Data
(60) Provisional application No. 62/535,429, filed on Jul. 21, 2017.

(51) Int. Cl. G06K 9/00; G06K 9/34; G06K 9/62; G06N 5/04

(52) U.S. Cl. CPC G06K 9/00335; G06N 5/04; G06K 9/6227; G06K 9/342

(57) ABSTRACT

A method of gesture detection in a controller includes: storing, in a memory connected with the controller, inference model data defining inference model parameters for a plurality of gestures; obtaining, at the controller, motion sensor data; extracting an inference feature from the motion sensor data; selecting, based on the inference feature and the inference model data, a detected gesture from the plurality of gestures; and presenting the detected gesture

### CROSS-REFERENCE TO RELATED APPLICATION

This application claims priority from U.S. provisional patent application No. 62/535,429, filed Jul. 21, 2017, the contents of which is incorporated herein by reference.

### FIELD

The specification relates generally to motion sensing technologies, and specifically to a method, system and apparatus for gesture recognition.

### BACKGROUND

Detecting predefined gestures from motion sensor data (e.g. accelerometer and/or gyroscope data) can be computationally complex, and may therefore not be well-supported by certain platforms, such as low-cost embedded circuits. As a result, deploying gesture recognition capabilities in such embedded systems may be difficult to achieve, and may result in poor functionality. Further, the definition of gestures for recognition and the deployment of such gestures to various devices, including the above-mentioned embedded systems, may require separately re-creating gestures for each deployment platform.

### SUMMARY

An aspect of the specification provides a method of gesture detection in a controller, comprising: storing, in a memory connected with the controller, inference model data defining inference model parameters for a plurality of gestures; obtaining, at the controller, motion sensor data; extracting an inference feature from the motion sensor data; selecting, based on the inference feature and the inference model data, a detected gesture from the plurality of gestures; and presenting the detected gesture.

Another aspect of the specification provides a method initializing gesture classification, comprising: obtaining initial motion data defining a gesture, the initial motion data having an initial first axial component and an initial second axial component; generating synthetic motion data by: generating an adjusted first axial component; generating an adjusted second axial component; and generating a plurality of combinations from the initial first and second axial components, and the adjusted first and second axial components; labelling each of the plurality of combinations with an identifier of the gesture; and providing the plurality of combinations to an inference model for determination of inference model parameters corresponding to the gesture.

A further aspect of the specification provides a method of generating data representing a gesture, comprising: receiving a graphical representation at a controller from an input device, the graphical representation defining a continuous trace in at least a first dimension and a second dimension; generating a first sequence of motion indicators corresponding to the first dimension, and a second sequence of motion indicators corresponding to the second dimension, each motion indicator containing a displacement in the corresponding dimension; and storing the first and second sequences of motion indicators in a memory.

### BRIEF DESCRIPTIONS OF THE DRAWINGS

Embodiments are described with reference to the following figures, in which:

FIG. 1 depicts a system for gesture recognition;

FIG. 2 depicts certain internal components of the client device and server of the system of FIG. 1;

FIG. 3 depicts a method of gesture definition and recognition in the system of FIG. 1;

FIGS. 4A-4B depict input data processed in the definition of a gesture;

FIG. 5 depicts a method for performing block 315 of the method of FIG. 3;

FIGS. 6A-6B illustrate performances of the method of FIG. 5;

FIGS. 7A-7B and 8A-8B illustrate additional example performances of the method of FIG. 5;

FIG. 9 illustrates an example output of block 315 of the method of FIG. 3;

FIG. 10 depicts a method of performing block 325 of the method of FIG. 3;

FIGS. 11-14 illustrate example data generated via performance of the method of FIG. 11;

FIG. 15 depicts a method of extracting features from motion data;

FIG. 16 depicts a method of performing block 345 of the method of FIG. 3;

FIG. 17 illustrates an example preprocessing function in the method of FIG. 16;

FIG. 18 depicts a method of detecting rotational gestures; and

FIG. 19 depicts a state diagram corresponding to the method of FIG. 18.

### DETAILED DESCRIPTION

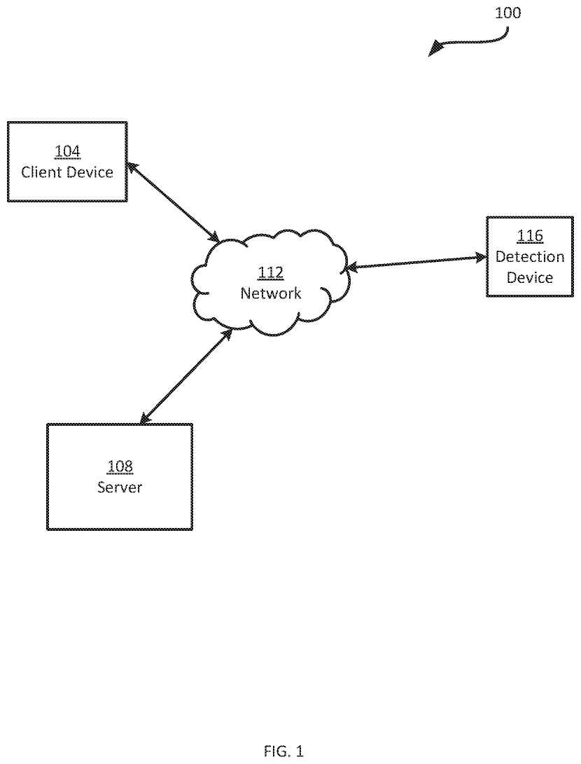

FIG. 1 depicts a system 100 for gesture recognition including a client computing device 104 (also referred to simply as a client device 104 or a device 104) interconnected with a server 108 via a network 112. The device 104 can be any one of a variety of computing devices, including a smartphone, a tablet computer and the like. As will be discussed below in greater detail, in the illustrated example, the client device 104 is enabled to detect and measure movement of the client device 104 itself, e.g. caused by manipulation of the client device 104 by an operator (not shown).

The client device 104 and the server 108 are configured, as will be described herein in greater detail, to interact via the network 112 to define gestures for subsequent recognition, and to generate inference model data (e.g. defining a classification model, a regression model, or the like) for use in recognizing the defined gestures from motion data collected with any of a variety of motion sensors. The motion data may be collected at the client device 104 itself, and/or at one or more detection devices, an example detection device 116 of which is shown in FIG. 1. The detection device 116 can be any one of a variety of computing devices, including a further smartphone, tablet computer or the like, a wearable device such as a smartwatch, a heads-up display, and the like.

In other words, the client device 104 and the server 108 are configured to interact to define gestures for recognition and generation the above-mentioned inference model data enabling the recognition of the defined gestures. The client device 104, the server 108, or both, can also be configured to deploy the inference model data to the detection device 116 (or any set of detection devices) to enable the detection device 116 to recognize the defined gestures. To that end, the detection device 116 can be connected to the network 112 as shown in FIG. 1. In other embodiments, however, the detection device 116 need not be persistently connected to the network 112, and in some embodiments the device 116 may never be connected to the network 112. Various deployment mechanisms for the above-mentioned inference model data will be discussed in greater detail herein.

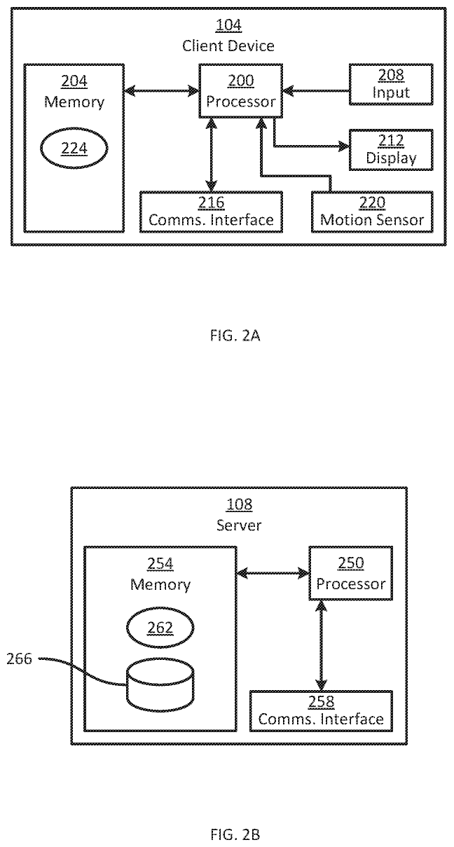

Before discussing the definition of gestures, the generation of inference model data, and the use of the inference model data to recognize gestures from collected motion data within the system 100, certain internal components of the client device 104 and the server 108 will be discussed, with reference to FIGS. 2A and 2B.

Referring to FIG. 2A, the client device 104 includes a central processing unit (CPU), also referred to as a processor 200, interconnected with a non-transitory computer readable storage medium, such as a memory 204. The memory 204 includes any suitable combination of volatile (e.g. Random Access Memory (RAM)) and non-volatile (e.g. read only memory (ROM), Electrically Erasable Programmable Read Only Memory (EEPROM), flash) memory. The processor 200 and the memory 204 each comprise one or more integrated circuits (ICs).

The device 104 also includes an input assembly 208 interconnected with the processor 200, such as a touch screen, a keypad, a mouse, or the like. The input assembly 208 illustrated in FIG. 2A can include more than one of the above-mentioned input devices. In general, the input device 208 receives input and provides data representative of the received input to the processor 200. The device 104 further includes an output assembly, such as a display 212 interconnected with the processor 200 (and, in the present example, integrated with the above-mentioned touch screen). The device 104 can also include other output assemblies (not shown), such as speaker, an LED indicator, and the like. In general, the display 212, and any other output assembly included in the device 104, is configured to receive output from the processor 200 and present the output, e.g. via the emission of sound from the speaker, the rendering of graphical representations on the display 212, and the like.

The device 104 further includes a communications interface 216, enabling the device 104 to exchange data with other computing devices, such as the server 108 and the detection device 116 (e.g. via the network 112). The communications interface 216 includes any suitable hardware (e.g. transmitters, receivers, network interface controllers and the like) allowing the device 104 to communicate according to one or more communications standards implemented by the network 112. The network 112 is any suitable combination of local and wide-area networks, and therefore, the communications interface 216 may include any suitable combination of cellular radios, Ethernet controllers, and the like. The communications interface 216 may also include components enabling local communication over links distinct from the network 112, such as Bluetooth™ connections.

The device 104 also includes a motion sensor 220, including one or more of an accelerometer, a gyroscope, a magnetometer, and the like. In the present example, the motion sensor 220 is an inertial measurement unit (IMU) including each of the above-mentioned sensors. For example, the IMU typically includes three accelerometers configured to detect acceleration in respective axes defining three spatial dimensions (e.g. X, and Z). The IMU can also include gyroscopes configured to detect rotation about each of the above-mentioned axes. Finally, the IMU can also include a magnetometer. The motion sensor 220 is configured to collect data representing the movement of the device 104 itself, referred to herein as motion data, and to provide the collected motion data to the processor 200.

The components of the device 104 are interconnected by communication buses (not shown), and powered by a battery or other power source, over the above-mentioned communication buses or by distinct power buses (not shown).

The memory 204 of the device 104 stores a plurality of applications, each including a plurality of computer readable instructions executable by the processor 200. The execution of the above-mentioned instructions by the processor 200 causes the device 104 to implement certain functionality, as discussed herein. The applications are therefore said to be configured to perform that functionality in the discussion below. In the present example, the memory 204 of the device 104 stores a gesture definition application 224, also referred to herein simply as the application 224. The device 104 is configured, via execution of the application 224 by the processor 200, to interact with the server 108 to create and edit gesture definitions for later recognition (e.g. via testing at the client device 104 itself). The device 104 can also be configured via execution of the application 224 to deploy inference model data resulting from the above creation and editing of gesture definitions to the detection device 116.

In other examples, the processor 200, as configured by the execution of the application 224, is implemented as one or more specifically-configured hardware elements, such as field-programmable gate arrays (FPGAs) and/or application-specific integrated circuits (ASICs).

Turning to FIG. 2B, the server 108 includes a central processing unit (CPU), also referred to as a processor 250, interconnected with a non-transitory computer readable storage medium, such as a memory 254. The memory 254 includes any suitable combination of volatile (e.g. Random Access Memory (RAM)) and non-volatile (e.g. read only memory (ROM), Electrically Erasable Programmable Read Only Memory (EEPROM), flash) memory. The processor 250 and the memory 254 each comprise one or more integrated circuits (ICs).

The server 108 further includes a communications interface 258, enabling the server 108 to exchange data with other computing devices, such as the client device 104 and the detection device 116 (e.g. via the network 112). The communications interface 258 includes any suitable hardware (e.g. transmitters, receivers, network interface controllers and the like) allowing the server 108 to communicate according to one or more communications standards implemented by the network 112, as noted above in connection with the communications interface 216 of the client device 104.

Input and output assemblies are not shown in connection with the server 108. In some embodiments, however, the server 108 may also include input and output assemblies (e.g. keyboard, mouse, display, and the like) interconnected with the processor 250. In further embodiments, such input and output assemblies may be remote to the server 108, for example via connection to a further computing device (not shown) configured to communicate with the server 108 via the network 112.

The components of the server 108 are interconnected by communication buses (not shown), and powered by a battery or other power source, over the above-mentioned communication buses or by distinct power buses (not shown).

The memory 254 of the server 108 stores a plurality of applications, each including a plurality of computer readable instructions executable by the processor 250. The execution of the above-mentioned instructions by the processor 250 causes the server 108 to implement certain functionality, as discussed herein. The applications are therefore said to be configured to perform that functionality in the discussion below. In the present example, the memory 254 of the server 108 stores a gesture control application 262, also referred to herein simply as the application 262. The server 108 is configured, via execution of the application 262 by the processor 250, to interact with the client device 104 to generate gesture definitions for storage in a repository 266. The server 108 is also configured to generate inference model data based on at least a subset of the gestures in the repository 266. The server 108 is further configured to employ the inference model data to recognize gestures in received motion data (e.g. from the client device 104), and can also be configured to deploy the inference model data to other devices such as the client device 104 and the detection device 116 to enable those devices to recognize gestures.

In other examples, the processor 250, as configured by the execution of the application 262, is implemented as one or more specifically-configured hardware elements, such as field-programmable gate arrays (FPGAs) and/or application-specific integrated circuits (ASICs).

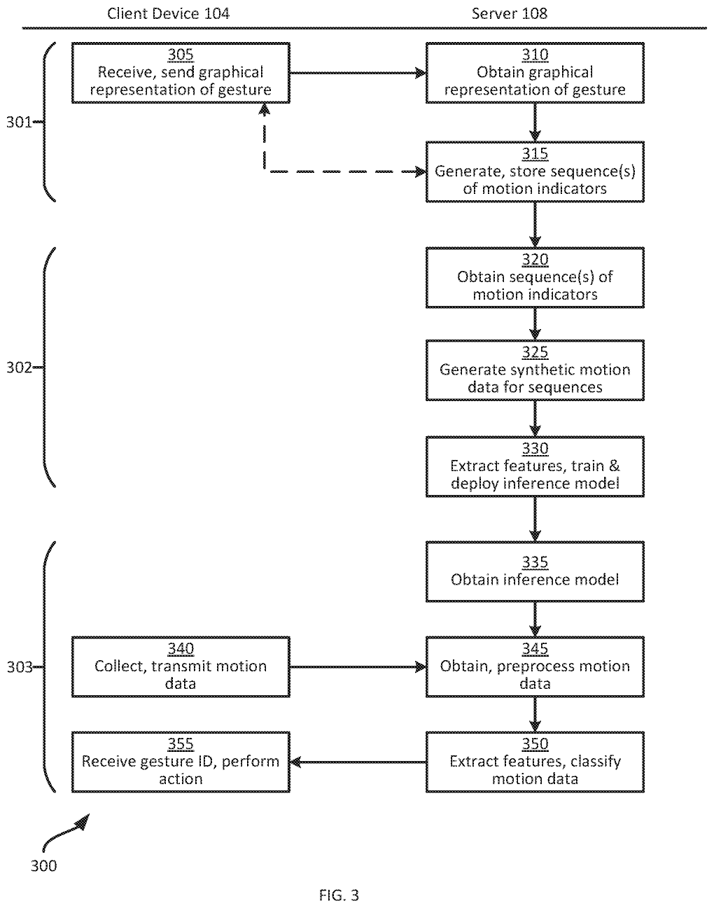

The functionality implemented by the system 100 will now be described in greater detail with reference to FIG. 3. FIG. 3 illustrates a method 300 of gesture definition and recognition, which will be described in conjunction with its performance in the system 100. The method 300 is illustrated as having three phases: a gesture definition phase 301 in which gestures are defined and stored for subsequent processing to enable their detection; a deployment phase 302, in which inference model data is generated corresponding to the gestures defined in the phase 301, enabling detection of the gestures; and a recognition phase 303, in which the above-mentioned inference data is employed to detect the gestures defined in the phase 301 within collected motion data. The phases 301-303 will be discussed in sequence below, although it will be understood that the phases 301-303 need not be performed contemporaneously. That is, the inference model generation phase 302 can immediately follow the gesture definition phase 302, or can be separated from the gesture definition phase 302 by a substantial period of time.

Certain steps of the method 300 as illustrated are performed by the client device 104, while other steps of the method 300 as illustrated are performed by the server 108. In other embodiments, as will be discussed further below, certain blocks of the method 300 can be performed by the client device 104 rather than by the server 108, and vice versa. In further embodiments, certain blocks of the method 300 can be performed by the detection device 116 rather than the client device 104 or the server 108. More generally, a variety of divisions of functionality defined by the method 300 between the components of the system 100 are contemplated, and the particular division of functionality shown in FIG. 3 is shown simply for the purpose of illustration.

At block 305, the client device 104 is configured to receive a graphical representation of a gesture for definition (to enable later recognition of the gesture). The graphical representation, upon receipt at the client device 104, is transmitted to the server 108 for processing. Receipt of the graphical representation at block 305 can occur through various mechanisms. For example, at block 305 the client device 104 can retrieve a previously generated image depicting a gesture from the memory 204. In the present example, the receipt of the graphical representation is effected by receipt of input data via the input assembly 208 (e.g. a touch screen, as noted earlier). The graphical representation is a single continuous trace representing a gesture as a path in space. Prior to receiving the input data, the client device 104 can be configured to prompt an operator of the client device 104 for a number of dimensions (e.g. two or three) in which to receive the graphical representation. In the examples below, two-dimensional gestures occurring within the XY plane of a three-dimensional frame of reference are discussed for clarity of illustration. However, it will be apparent to those skilled in the art that graphical representations of three-dimensional gestures can be received at the client device 104 according to the same mechanisms as discussed below.

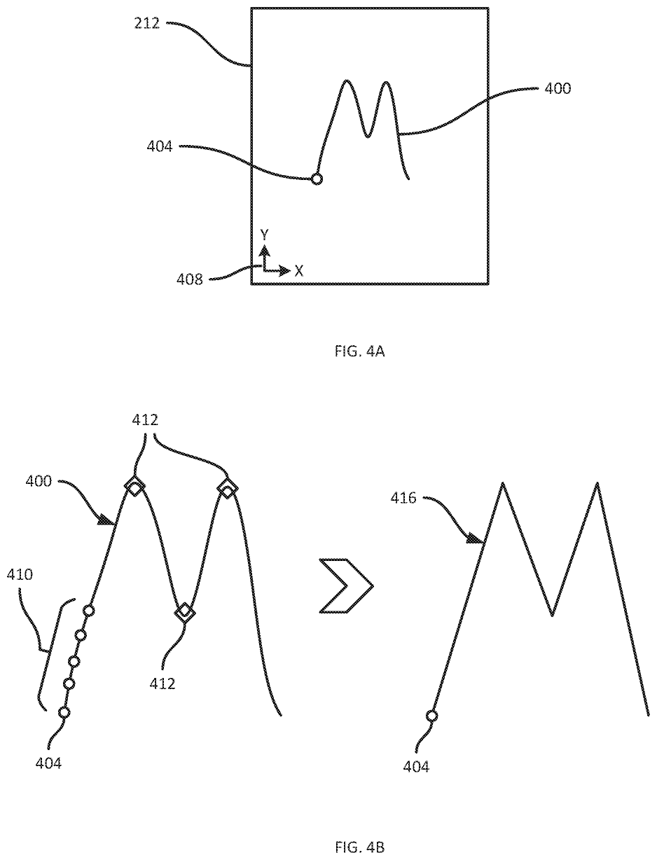

Turning to FIG. 4A, the display 212 of the client device 104 is illustrated following receipt of input data defining a graphical representation 400 of a gesture in the shape of an upper-case “M”. The graphical representation 400 was received via activation of a touch screen integrated with the display 212 in the present example, in the form of a continuous trace beginning at a start point 404 and defining the “M” in the XY plane, as indicated by a frame of reference indicator 408 that may also be rendered on the display 212. Following receipt of the graphical representation 400, the client device 104 is configured to transmit the graphical representation 400 to the server 108 for further processing. The graphical representation 400 can be transmitted to the server 108 along with an identifier (e.g. a name for the gesture).

Returning to FIG. 3, at block 310 the server 108 is configured to obtain the graphical representation 400 transmitted by the client device 104. In other examples, in which the client device 104 itself performs certain functionality illustrated as being implemented by the server 108 in FIG. 3, the performance of block 310 coincides with the performance of block 305 (that is, the client device 104 obtains the graphical representation 400 by receiving the above-mentioned input data).

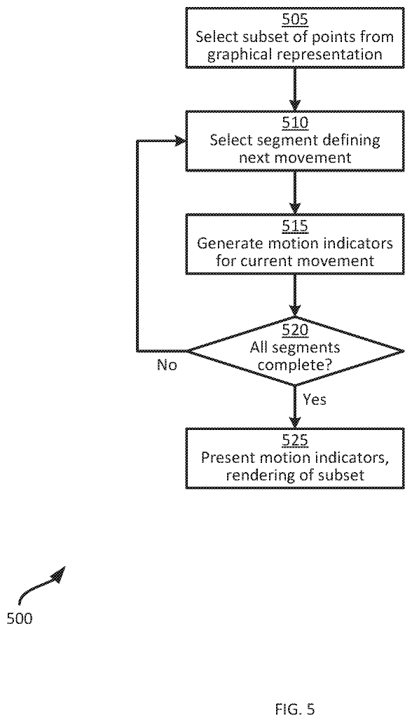

At block 315, the server 108 is configured to generate and store at least one sequence of motion indicators that define a gesture corresponding to the graphical representation 400. In particular, the server 108 is configured to generate a sequence of motion indicators for each dimension of the graphical representation 400. Thus, in the present example, the server 108 is configured to generate a first sequence of motion indicators for the X dimension, and a second sequence of motion indicators for the Y dimension. The generation of motion indicators will be described in greater detail in connection with FIG. 5. In other examples, blocks 305 and 310 can be omitted, and the client device 104 can simply provide a sequence of motion indicators to the server 108 as input, rather than providing a graphical representation of a gesture as described above. The generation of the sequence, in such examples, therefore consists simply of receiving the sequence of motion indicators (e.g. from the client device 104).

FIG. 5 illustrates a method 500 for generating sequences of motion indicators corresponding to a graphical representation of a gesture (e.g. the graphical representation 400). That is, the method 500 is an example method of performing block 315 of the method 300. The generation of sequences of motion indicators is also referred to herein as scripting, or the generation of script elements.

At block 505, the server 108 can be configured to select a subset of points from the graphical representation 400 to retain for further processing. In some embodiments, block 505 may be omitted; the selection of a subset of points serves to simplify the graphical representation 400, e.g. straightening lines and smoothing curves to reduce the number of individual movements that define the gesture. As will now be apparent, the graphical representation 400 can be represented as a series of points at any suitable resolution (e.g. as a bitmap image). Turning to FIG. 4B, the graphical representation 400 is shown with certain points 410 highlighted, including the start point 404 (it will be understood that the resolution of the points defining the graphical representation 400 may be higher or lower than that shown by the points 410).

The selection of a subset of points at block 505 includes identifying sequences of adjacent points that lie on the same vector (i.e. the same straight line), and retaining only the first and last points of the sequence. For example, the server 108 can be configured to select an adjacent pair of points (e.g. the first and second points of the graphical representation 400) and determine a vector (i.e. a direction) defined by a segment extending between the pair of points. The server 108 is then configured to select the next point (e.g. the third point of the graphical representation 400) and determine a vector defined by the next point and the second point of the initial pair. If the vectors are equal, or deviate by less than a threshold (e.g. ten degrees, although greater or smaller thresholds may be applied in other embodiments), only the first point and the last point evaluated are retained. The server 108 can also be configured to identify curves in the graphical representation, and to smooth the curves by any suitable operation or set of operations, examples of which will occur to those skilled in the art.

The server 108 can also be configured to identify corners in the graphical representation 400, and to replace a set of points defining each corner with a single vertex point. For example, a corner may be defined as a set of adjacent points of a predetermined maximum length that define a directional change greater than a threshold (e.g. 30 degrees, although greater or smaller thresholds may be applied in other embodiments). In other words, the server 108 can be configured to detect as a corner a set of points that, although curved in the graphical representation 400, define a sharp change in direction. Three example corners 412 are illustrated in FIG. 4B. In some examples, the server 108 is configured, prior to replacing corner regions with single vertices; to return the graphical representation 400 to the client device 104 along with indications of detected corners to prompt an operator of the client device 104 for acceptance of the corners, addition of further corners, removal of detected corners (to prevent the replacement of the detected corners with single vertices), or the like.

FIG. 4B also illustrates an example result of the performance of block 505, in the form of an updated graphical representation 416 consisting of a subset of five points from the initial graphical representation 400, with straight lines extending between the points. In other words, where the graphical representation 400 defined a greater number of vectors extending between adjacent pairs of points, the updated graphical representation defines only five vectors, while substantially retaining the overall shape from the graphical representation 400.

Referring again to FIG. 5, at block 510 the server 108 is configured to select a segment of the updated representation 416 defining a movement in one of the dimensions of the representation 416, beginning at the start point 404. Segments defining movements in the updated representation are segments that are bounded by at least one of a change in direction in the selected dimension (that is, a reversal of direction) and a corner 412. In other embodiments, the identification of segments defining movement may ignore corners, for example. More generally, the server 108 is configured to identify segments that indicate an acceleration and an accompanying deceleration (i.e. an acceleration in the opposite direction) in the relevant dimension.

At block 515, the server 108 is configured to generate a motion indicator for the segment identified at block 510. The motion indicator generated at block 515 indicates a displacement in the relevant dimension corresponding to the segment identified at block 510. At block 520, the server 108 is configured to determine whether the entire updated representation 416 has been traversed (i.e. whether all movements identified, in all dimensions, have been processed). When the determination at block 520 is negative, blocks 510 and 515 are repeated until a sequence of motion indicators has been generated covering the entire updated representation 416 in each relevant dimension (i.e. in the X and Y dimensions, in the illustrated examples).

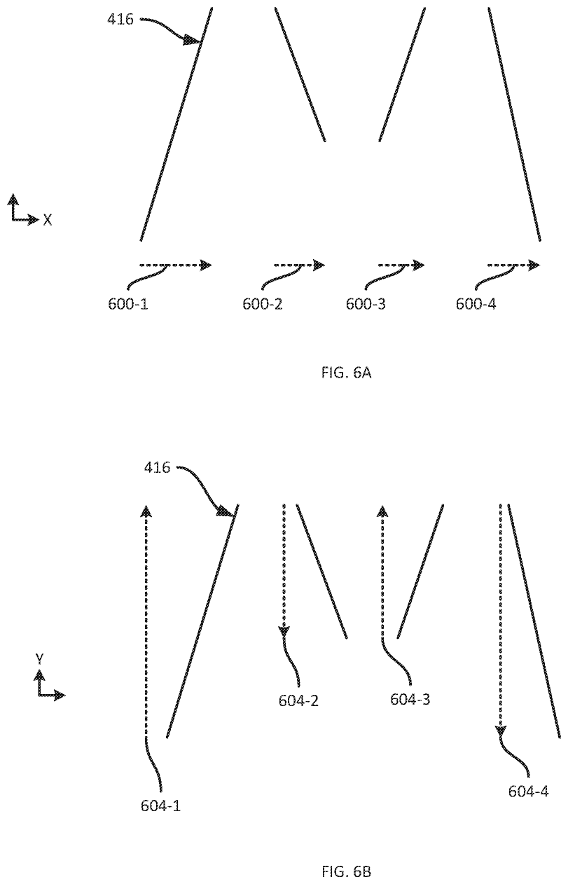

Turning to FIG. 6A, the updated representation 416 is shown with the above-mentioned five vectors separated for clarity of illustration. FIG. 6A illustrates four movements 600-1, 600-2, 600-3 and 600-4 identified at successive performances of block 510. As shown in FIG. 6A, the movements 600 are all in the same direction along the X axis, but are identified at block 510 as distinct movements due to their separation by the corners 412 mentioned above. FIG. 6B illustrates four movements 604-1, 604-2, 604-3 and 604-4 identified at successive performances of block 510 in the Y dimension. As seen in FIG. 6B, the movements 604 are separated both by corners and by reversals (on the Y axis) in direction.

At block 515, as mentioned above, the server 108 generates a motion indicator (which may also be referred to as a script element) for each identified movement in each dimension. The motion indicators include displacement vectors (i.e, magnitude and direction), and also include displacement types. The displacement vectors are defined according to a common scale (i.e. a unit of displacement indicates the same displacement in either dimension) and may be normalized, for example relative to the first indicator generated. Table 1 illustrates motion indicators for the example of FIGS. 6A and 6B, with displacement magnitudes normalized against the movement 600-1.

TABLE 1
Example Script Elements for “M”

| Dimension | Element 1 | Element 2 | Element 3 | Element 4 |
|---|---|---|---|---|
| X | m = +1 | m = +0.7 | m = +0.63 | m = +0.72 |
| Y | m = +3.27 | m = −1.87 | m = +1.87 | m = −3.27 |

As seen above, each motion indicator includes a displacement vector (e.g. +1.87) and a displacement type. In the present example, each of the displacement types correspond to an indicator of movement (“m”). Other examples of displacement types will be discussed below. As will now be apparent, a gesture corresponding to the updated representation 416 can be defined by the set of eight indicators shown above.

Following an affirmative determination at block 520, indicating that motion indicators have been generated for the entirety of the updated representation 416, in each dimension defining the updated representation 416, the server 108 is configured to proceed to block 525. At block 525 the server 108 is configured to present the motion indicators and a rendering of the subset of the points selected at block 505. The rendering, in other words, is the updated representation 416, in the present example. The rendering and the motion indicators can be presented by returning them to the client device 104 for presentation on the display 212. In some examples, the rendering need not be provided to the same client device that transmitted the graphical representation at block 305. For example, the rendering and the sequence of motion indicators may be returned to an additional client device (such as a laptop, desktop or the like) for presentation. Returning to FIG. 3, the dashed line extending from block 315 to block 305 indicates that following presentation of the rendering and the motion indicators on the display 212, the client device 104 can request changes to the gesture as defined by the rendering (i.e. the updated representation 416) and the motion indicators 600 and 604, For example, the client device 104 can submit one or more edits to the motion indicators received from the server 108 (e.g. in response to input data received via the input assembly 208). When edits are received at the server 108 for one or more script elements, the server 108 is configured to store the updated motion indicators, and also to further update the representation 416, for example by scaling the relevant portion of the representation 416 in the relevant dimension to reflect the updated motion indicators. Following the completion of any edits (e.g. signaled by the client device 104 sending an approval or the like to the server 108), the server 108 is configured to store the final graphical representation, the motion indicators, and the previously mentioned gesture identifier (e.g. a name) in the repository 266. Table 2 illustrates example final motion indicators for the “M” gesture, as stored in the repository 266 at block 315.

TABLE 2
Updated Script Elements for “M”

| Dimension | Element 1 | Element 2 | Element 3 | Element 4 |
|---|---|---|---|---|
| X | m = +1 | m = +0.5 | m = +0.5 | m = +1 |
| Y | m = +3 | m = −1.5 | m = +1.5 | m = −3 |

As will now be apparent, the first phase 301 of the method 300 can be repeated to define additional gestures. Before continuing with the description of the performance of the method 300 (i.e. with a discussion of the phases 302 and 303), additional examples of gesture definitions will be discussed, to further illustrate the concept of representing gestures with motion indicators derived from graphical representations.

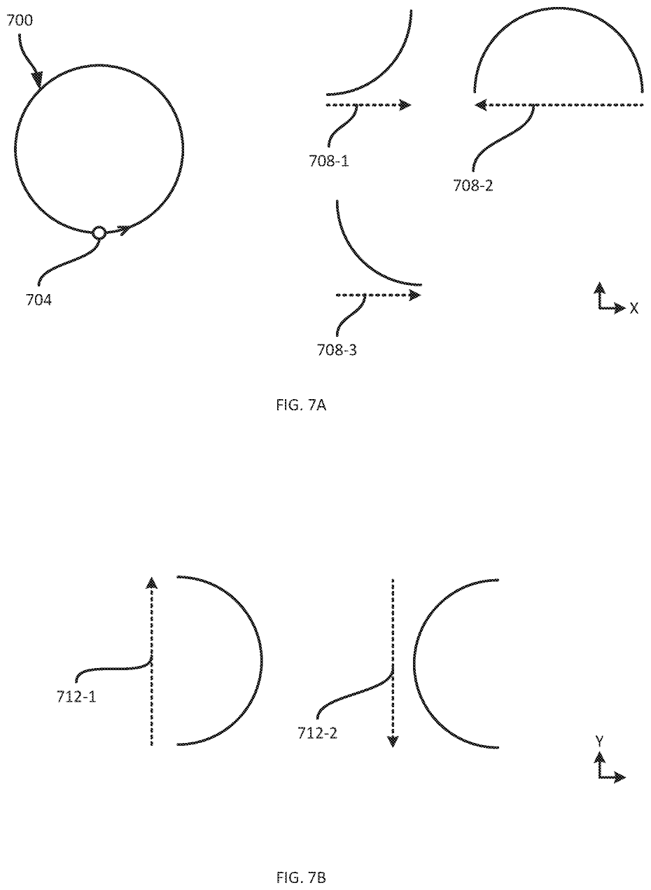

Turning to FIGS. 7A and 7B, a graphical representation 700 of a counterclockwise circular gesture with a start point 704 is shown. FIG. 7A illustrates three movements 708-1, 708-2, 708-3 in the X dimension identified at block 510. Each movement 708, as will now be apparent, is bounded by a reversal in direction (in the X dimension), FIG. 7B illustrates two movements 712-1, 712-2 in the Y dimension identified at block 510. Table 3 illustrates example motion indicators generated at block 515 for the representation 700.

TABLE 3
Example Script Elements for “O”

| | | | |
|---|---|---|---|
| X | m = +1 | m = −2 | m = +1 |

| | | |
|---|---|---|
| Y | m = +2 | m = −2 |

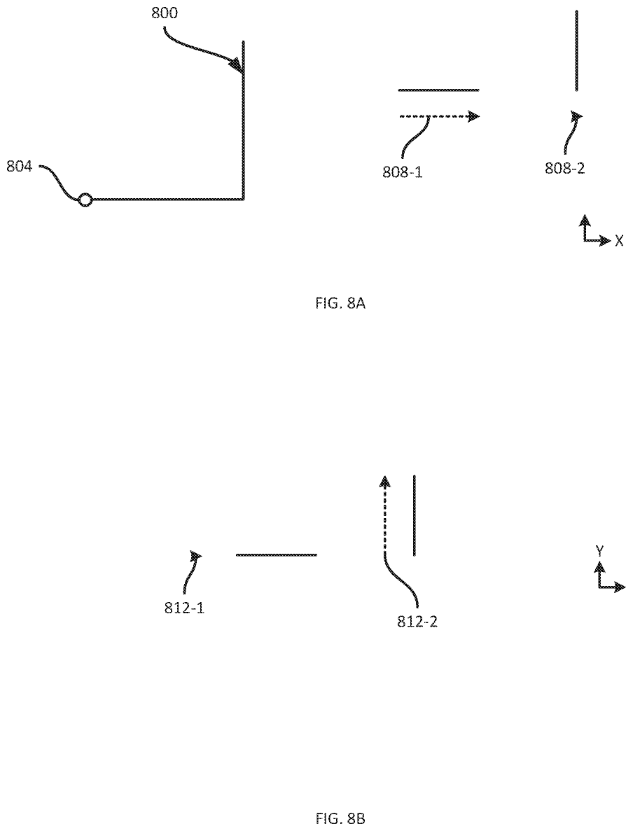

Turning to FIGS. 8A and 8B, a graphical representation 800 of a right-angle gesture with a start point 804 is shown. FIG. 8A illustrates two movements 808-1, 808-2, in the X dimension identified at block 510. Of particular note, the second movement 808-2 is null in the X direction. That is, although movement occurs in the representation 800 from the end of the movement 808-1 to the termination of the representation 800, that movement occurs outside the X dimension. Therefore, the movement 808-2, as will be seen below, includes a displacement type of “stop” (or “s”, in Table 4 below) indicating that for the indicated displacement, there is movement in other dimensions, but not in the X dimension. Similarly, FIG. 8B illustrates two movements 712-1, 712-2 in the Y dimension as identified at block 510. The movement 812-1, like the movement 808-2, is a null movement, and is therefore represented by a “stop”-type motion indicator. Table 4 illustrates example motion indicators generated at block 515 for the representation 800. As shown in Table 8, stop-type motion indicators need not include directions (i.e. signs preceding the displacement magnitude).

TABLE 4
Example Script Elements for “┘”

| Dimension | Element 1 | Element 2 |
|---|---|---|
| X | m = +1 | s = 1 |
| Y | s = 1 | m = +1 |

A further displacement type contemplated herein is the move-pause (which may also be referred to as move-stop) displacement. A move-pause displacement may be represented by the string “nip” (rather than “m” as in Tables 1-4), and indicates a brief pause at the end of the corresponding movement. As will be discussed in greater detail below, in connection with the generation of synthetic motion data, a move-pause displacement indicates that a motion sensor such as an accelerometer is permitted to recover (i.e. return to zero) before the next movement begins, whereas a move type displacement indicates that the motion sensor is not permitted to recover before the next movement begins.

In some examples, the server 108 is configured to generate move-pause type displacements for movements terminating at corners (e.g. the corners 412 of the “M” gesture). Thus, in such examples the motion indicators for the “M” gesture can specify move-pause type displacements rather than move type displacements as shown above. In other examples, the server 108 can be configured to automatically generate two sets of motion indicators for each gesture: a first set employing move type displacements, and a second set employing move-pause type displacements.

Returning to FIG. 3, the second phase 302 of the method 300 will now be discussed. As noted above, the second phase 302 involves the generation of inference model data for deployment to one or more computing devices (e.g. the client device 104, the detection device 116 and the like) to enable those devices to recognize gestures. The inference model data discussed herein is a classification model, such as a Softmax regression model. A wide variety of other inference models may also be employed, including neural networks, support vector machines (SVM), and the like. The inference model data therefore includes a set of parameters (e.g. node weights or the like) that enable a computing device implementing the inference model to receive one or more inputs (typically referred to as input features, or simply features), and to generate an output from the inputs. In the present discussion, the output is one of a plurality of gestures that the inference model has been configured to recognize.

As will now be apparent to those skilled in the art, generating inference model data (e.g. to classify gestures) typically requires the processing of a set of labelled training data. The training process adjusts the parameters of the inference model data to produce outputs that match the correct labels provided with the training data. The second phase 302 of the method 300 is directed towards generating the above-mentioned training data synthetically (i.e. without capturing actual motion data from motion sensors such as the motion sensor 220 of the client device 104), and executing any suitable training process (a wide variety of examples of which will occur to those skilled in the art) to generate inference model data employing the synthetic training data.

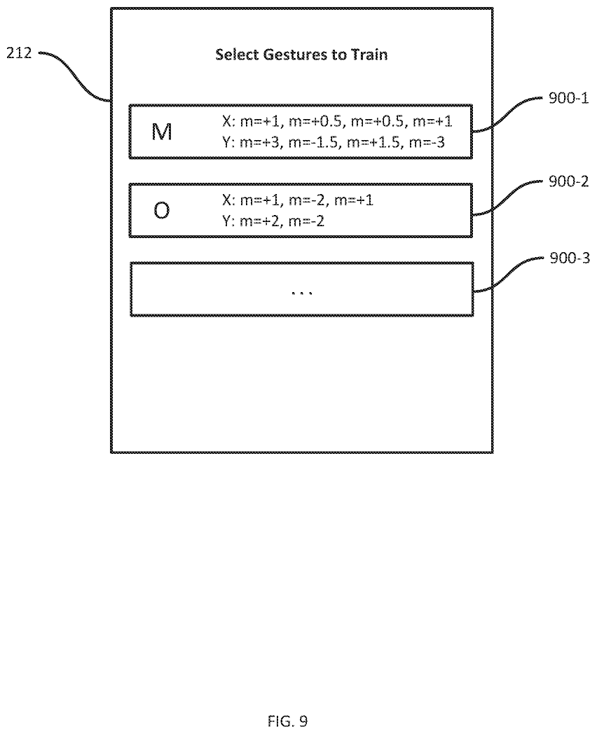

At block 320, the server 108 is configured to obtain one or more sequences of motion indicators defining at least one gesture. In some embodiments, obtaining the sequences of motion indicators at block 320 includes retrieving all defined gestures (via the phase 301 of the method 300) from the repository 266. In other examples, a subset of the gestures defined in the repository 266 are retrieved at block 320. For example, the server 108 can be configured (e.g. in response to an instruction from the client device 104, or an additional client device as mentioned above, to begin the generation of inference model data) to present a list of available gestures in the repository 266 to the client device 104, and to receive a selection of at least one of the presented gestures from the client device 104. Turning briefly to FIG. 9, the display 212 of the client device 104 is shown presenting a set of selectable gesture definitions 900-1, 900-2, 900-3 and so on. The client device 104 is configured to receive selections of one or more of the gesture definitions 900 and to transmit the selections to the server 108, for receipt at block 320.

At block 325, the server 108 is configured to generate synthetic motion data for each of the sequences obtained at block 320 (that is, for each gesture selected at block 320, in the present example). The synthetic motion data, in the present example, is accelerometer data. That is, the synthetic motion data is data mimicking data (specifically, one stream of data for each dimension) that would be captured by an accelerometer during performance of the corresponding gesture. Further, at block 325 the server 108 is configured to generate a plurality of sets of synthetic data; together representing a sufficient number of training samples to train an inference model.

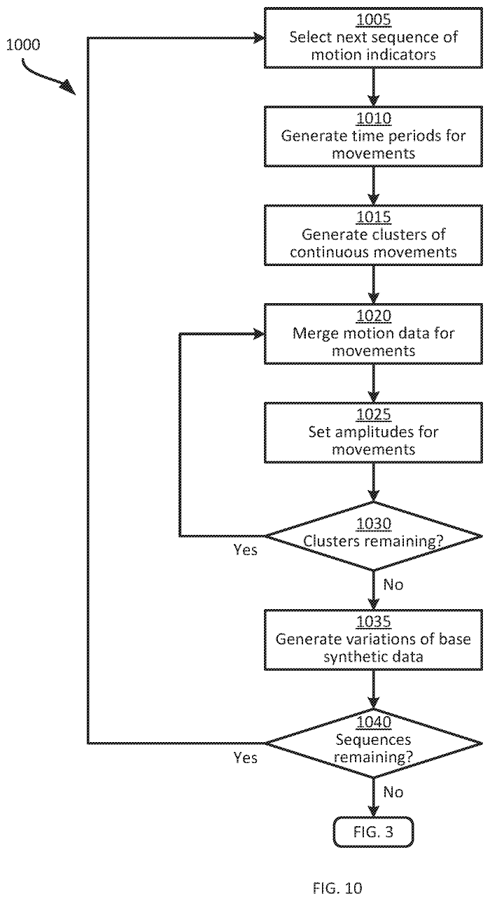

Turning to FIG. 10, a method 1000 of generating synthetic motion data is illustrated. That is, the method 1000 is an example method of performing block 325 of the method 300.

At block 1005, the server 108 is configured to select the next sequence of motion indicators for processing. That is, the server 108 is configured to select the next gesture, of the gestures obtained at block 320, for processing (e.g. beginning with the gestures “M” in the present example). In the subsequent blocks of the method 1000, the server 108 is configured to generate synthetic accelerometer data for each dimension of the selected gesture. The synthetic accelerometer data for a given dimension of a given gesture generally (with certain exceptions, discussed below) includes a single period of a sine wave for each movement in the gesture. The single-period sine wave, as will be apparent to those skilled in the art, includes a positive peak and a negative peak, indicating an acceleration and a deceleration in the relevant dimension. The generation of synthetic motion data therefore includes determining amplitudes (i.e. accelerations) and lengths (i.e. time periods) for each single-period sine wave, based on the motion indicators defining the gesture.

At block 1010, the server 108 is configured to generate time periods corresponding to each movement defined by the motion indicators. Thus, for the “M” gesture discussed above, at block 1010 the server 108 is configured to determine respective time periods corresponding to each of the movements 600 shown in FIG. 6A (the process is then repeated for each of the movements 604 shown in FIG. 6B). The generation of time periods at block 1010 is performed on the basis of the relationship between distance, acceleration and time, as will be familiar to those skilled in the art. In the present example; initial velocity and initial displacement are assumed to be zero, and the relationship is therefore simplified as follows:

d=½at²

In the above equation, “d” represents displacement, as defined in the motion indicators, “a” represents acceleration, and “t” represents time. The acceleration values, at block 1010, are assigned arbitrarily, for example as a single common acceleration for each movement. The time for each movement therefore remains unknown. By assigning equal accelerations to each movement, the acceleration component of the relationship can be removed, for example by forming the following ratio for each pair of adjacent movements:

$$\frac{{d}_{1}}{{d}_{2}} = {( \frac{{t}_{1}}{{t}_{2}} )}^{2}$$

The ratios of displacements are known from the motion indicators defining the gesture. The server 108 is further configured to assume an arbitrary total duration (i.e. sum of all time periods for the movements), such as two seconds (though any of a variety of other time periods may also be employed). Thus, from the set of equations defining ratios of time periods, and the equation defining the sum of all time periods, the number of unknowns (the time period terms, specifically) matches the number of equations, and the set of equations can be solved for the value of each time period.

At block 1015, the server 108 is configured to generate clusters of continuous movements from the movements comprising the relevant dimension of the current gesture (e.g. the movements 600 in the X dimension of the “M” gesture). A movement is continuous with a previous movement if the motion indicator defining the previous movement does not indicate a pause or a stop (i.e. an interruption marker). Thus, adjacent movements defined by motion indicators containing move type displacements are grouped into common clusters, while adjacent movements defined by motion indicators containing move-pause or stop type displacements are placed in separate clusters. As will now be apparent; when the server 108 is configured to employ “mp” displacements for movements terminating at corners, all the movements 600 shown in FIG. 6A are placed in separate clusters. The movements 708 of the “0” gesture shown in FIG. 7A, however, are placed in a single cluster.

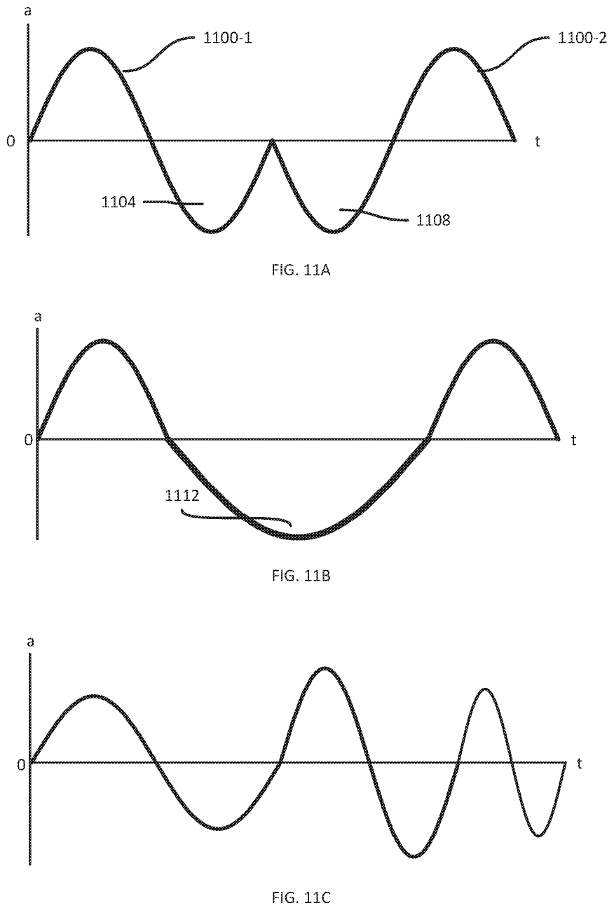

At block 1020, the server 108 is configured to merge motion data for certain movements within a given cluster. Specifically, the server 108 is configured to determine, for each pair of movements (i.e. each pair of single-period sine waves) in the cluster, whether the final half of the first movement defines an acceleration in the same direction as the initial half of the second movement. Turning to FIG. 11, two sequential movements 1100-1, 1100-2 are shown, in which the final portion 1104 of the first movement 1100-1 defines a negative acceleration, and the initial portion 1108 of the second movement 1100-2 also defines a negative acceleration. Because the movements 1100 are continuous (i.e. not separated by a pause or stop), it is assumed that a physical accelerometer, if travelling through the same movements, would be unable to return to zero (i.e. to recover) between the portion 1104 and the portion 1108. Therefore, the accelerometer would in fact detect a single negative acceleration rather than the two distinct negative accelerations shown in FIG. 11A.

To account for the above situation (in other words, to produce synthetic data more accurately reflecting data that would be produced by an accelerometer), the server 108 is configured to merge the portions 1104 and 1108 into a single half-movement, defined by a time period equal to the sum of the time periods of the portions 1104 and 1108 (i.e. the sum of one-half of the time period of movement 1100-1 and one-half of the time period of movement 1100-2). The resulting merged portion 1112 is shown in FIG. 11B, with the initial portion of the movement 1100-1 and the final portion of the movement 1100-2 remaining as in FIG. 11A. For adjacent movements having opposite final and initial accelerations, block 1020 is omitted.

Returning to FIG. 10, at block 1025, accelerations are determined for each half-wave (i.e. each half of a movement, or each merged portion, as applicable). As noted above, accelerations were initially set to a common arbitrary value for determination of time periods. At block 1025, therefore, given that time periods have been determined, amplitudes for each half-wave can be determined, for example according to the following:

$${a}_{1} = {a}_{max} \times sin ( \frac{π T}{{t}_{1}} ) , where {a}_{max} = \frac{2 d}{{t}^{2}}$$

In the above equation, “a” is the amplitude for a given half-wave, “T” is the sum of all time periods, and “t” is the time period corresponding to the specific half-wave under consideration. When each half-wave in the cluster has been fully defined by a time period and an amplitude as above, the server 108 determines, at block 1030, whether additional clusters remain to be processed. The above process is repeated for any remaining clusters, and as noted earlier, the process is then repeated for any remaining dimensions of the gesture (e.g. for the motion indicators defining movements in the Y dimension after those defining movements in the X direction have been processed). The result, in each dimension, is a series of time periods and accelerations that define synthetic accelerometer data corresponding to the motion indicators. FIG. 11C illustrates example synthetic accelerometer data corresponding to three movements, each having different time periods and accelerations.

In some embodiments, additional processing may be applied to the synthetic data to better simulate actual accelerometer data. For example, at block 1025, having set amplitudes as discussed above, the server 108 can be configured to generate updated amplitudes by deriving velocity from each amplitude (based on the corresponding time period). The server 108 is then configured to apply a non-linear functions, such as a power function to the velocity (e.g. to raise the velocity to a fixed exponent, previously selected and stored in the memory 254), and to then derive an updated acceleration from the velocity.

Following an negative determination at block 1030, indicating that an entire gesture has been processed, the server 108 is configured to proceed to block 1035 and generate a plurality of variations of the “base” synthetic data (e.g. shown in FIG. 11C) generated via the performance of blocks 1010-1030. The variations, coupled with the base synthetic data, form a set of training data to be employed in generating the inference model data mentioned earlier.

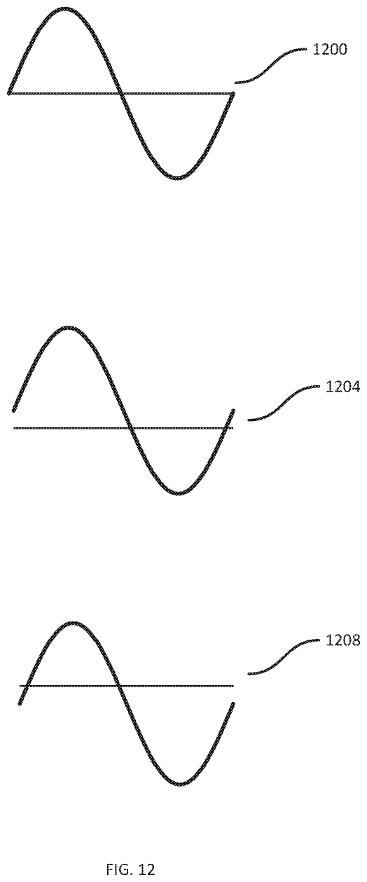

Various mechanisms are contemplated for generating variations of the base synthetic data. Turning to FIG. 12, in some examples variations can be generated by applying one or both of a positive and negative acceleration offset to the base synthetic data. For example, a base wave 1200 is shown, and two variations 1204 and 1208, resulting from a positive offset and a negative offset respectively, are also shown. Thus, for example, at block 1035, for base synthetic data in three dimensions, a total of twenty-seven sets of synthetic motion data can be generated at the server 108 by generating different permutations of the base, positive offset, and negative offset for each dimension.

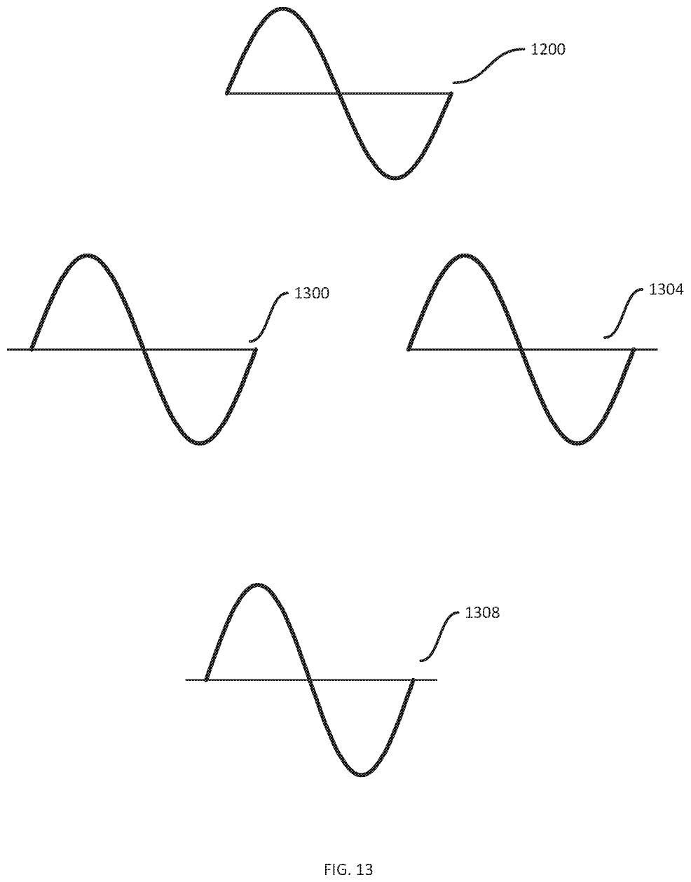

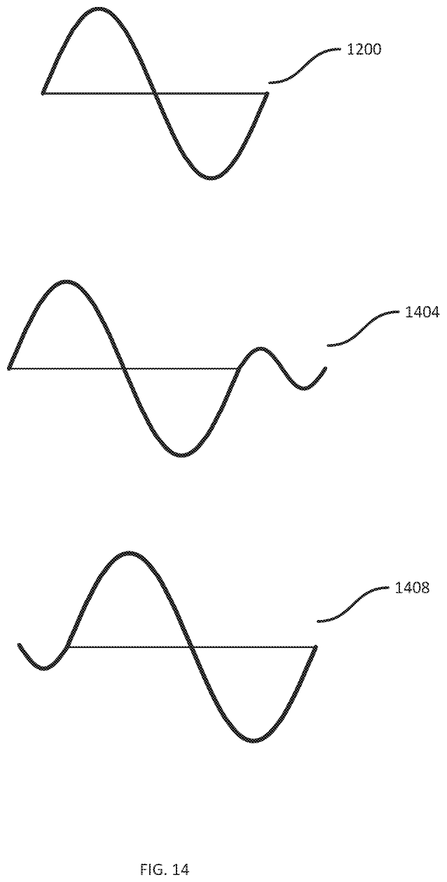

FIG. 13 illustrates another method of generating variations of the synthetic motion data. For example, from the base data 1200, three variations can be generated by prepending or appending pauses (showing no movement) to the base data 1200. Thus, first, second and third variations 1300, 1304 and 1308 are shown including, respectively, a prepended pause, an appended pause, and both prepended and appended pauses. FIG. 14 illustrates yet another method of generating variations of the synthetic motion data. In particular, the base data 1200 is shown along with a first variation 1404 and a second variation 1408 including, respectively, additional movements prepended or appended to the base data 1200. The additional movements can have any suitable amplitude and time periods, but are preferably smaller (in amplitude) and shorter (in time) than the base data 1200. Other variations can include both prepended and appended additional movements. The additional movements, as seen in the variations 1404 and 1408, can include any suitable combination of full and half-waves.

Returning to FIG. 10, at block 1040 the server 108 is configured to determine whether any sequences remain to be processed (that is, whether any of the gestures selected for inference model training remain to be processed). The performance of the method 1000 is repeated for each gesture until the determination at block 1040 is negative. Responsive to a negative determination at block 1040, indicating that the generation of all synthetic training data is complete, the server 108 returns to FIG. 3. Specifically, the server 108 is configured to return to proceed to block 330.

At block 330, the server 108 is configured to train the inference model (i.e. to generate inference model data) based on the synthetic training data generated at block 325 for the selected set of gestures. The server 108 is therefore configured to extract one or more features from each set of synthetic training data (e.g. from each of the base data 1200 and any variations thereto). Any of a variety of features may be employed to generate the inference model, as will be apparent to those skilled in the art. In the present example, the server 108 is configured to extract four feature vectors from the synthetic motion data. In particular, the server 108 is configured to generate two time-domain features, as well as frequency-domain representations of each time-domain feature.

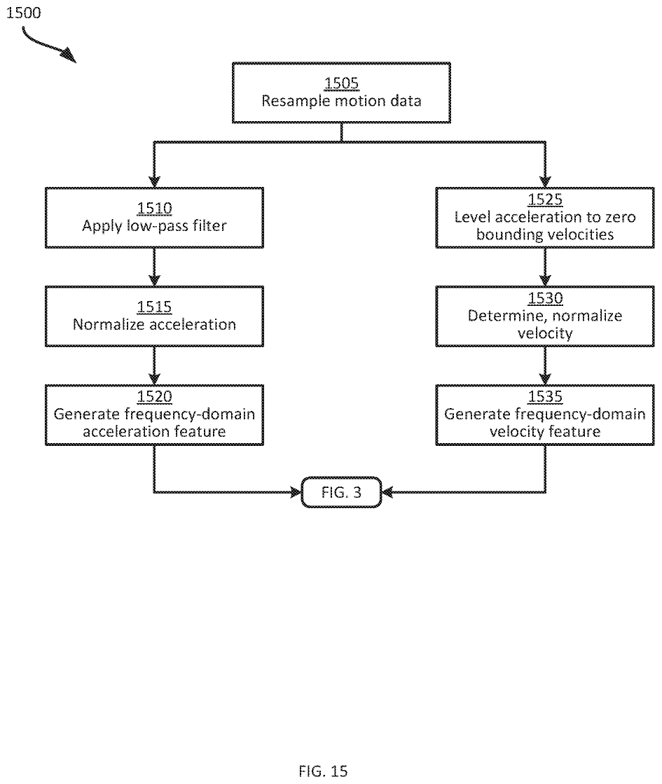

Turning to FIG. 15, a method 1500 for feature extraction is illustrated. At block 1505, the server 108 is configured to resample the synthetic motion data at a predefined sample rate. The server 108 is then configured to execute two branches of feature extraction, each corresponding to one of the above-mentioned time-domain features. In particular, in the first branch, at block 1510 the server 108 is configured to apply a low-pass filter to the motion data, followed by normalizing the acceleration of each sample from block 1505 (e.g. such that all samples have accelerations between −1 and 1). The normalized accelerations represent the first time-domain feature. That is, the first time-domain feature is a vector of normalized acceleration values (e.g. one acceleration value per half-wave of the motion data). Finally, at block 1520 the server 108 is configured to generate a frequency-domain representation of the vector generated at block 1515, for example by applying a fast Fourier transform (FFT) to the vector generated at block 1515. The resulting frequency vector is the first frequency-domain feature.

In the second branch of the method 1500, the server 108 is configured to level the accelerations in the motion data to place the velocity at the beginning and end of the corresponding gesture at zero. The velocity at the end of a gesture is assumed to be null (i.e. the device bearing the motion sensor(s) is presumed to have come to a stop), but motion data such as data collected from an accelerometer may contain signal errors, sensor drift and the like that results in the motion data defining a non-zero velocity by the end of the gesture. At block 1525, therefore, the server 108 is configured to determine the velocities defined by each half-wave of the motion data (i.e. the integral of each half-wave, as the area under each half-wave defines the corresponding velocity). The server 108 is further configured to sum the positive velocities together, and to sum the negative velocities, and to determine a ratio between the positive and negative velocities. The ratio (for which the sign may be omitted) is then applied to all positive accelerations (if the positive sum is the denominator in the ratio) or to all the negative accelerations (if the negative sum is the denominator in the ratio).

At block 1530, the server 108 is configured to determine corresponding velocities for each half-wave of the accelerometer data (e.g. by integrating each half-wave), and to normalize the velocities similarly to the normalization mentioned above in connection with block 1515. The vector of normalized velocities comprises the second time-domain feature. At block 1535 the server is configured to generate a frequency-domain representation of the vector generated at block 1530, for example by applying a fast Fourier transform (FFT) to the vector generated at block 1530. The resulting frequency vector is the second frequency-domain feature. Following generation of the feature vectors, the server 108 is configured to return to the method 300. In particular, in the present example the server 108 is configured to return to block 330.

At block 330, having extracted feature vectors, the server 108 is configured to generate inference model data. The generation of inference model data is also referred to as training the inference model, and a wide variety of training mechanisms will occur to those skilled in the art, according to the selected inference model. The result of training the inference model is a set of inference model parameters, which the server 108 is configured to deploy to conclude the performance of block 330. The inference model parameters include both configuration parameters for the inference model itself, and output labels employed by the inference model. For example, the output labels can include the gesture names obtained with the graphical representations at block 310.

Deploying the inference model data includes providing the inference model data, optionally with the updated graphical representations of the corresponding gestures, to any suitable computing device to be employed in gesture recognition. Thus, in the present example, in which the server 108 itself is configured to recognize gestures, deployment includes simply storing the inference model data in the memory 254. In other embodiments, the server 108 can also be configured to deploy the inference model data to the client device 104, the detection device 116, or the like. For example, the server 108 can be configured to receive a selection (e.g. from the client device 104) identifying a desired deployment device (e.g. the detection device 116). Responsive to the selection, the server 108 is configured to retrieve from the memory 254 not only the inference model data, but a set of instructions (e.g. code libraries and the like) executable by the selected device to extract the required features and employ the inference model data to recognize gestures. As such, the server 108 can be configured to deploy the same inference model data to a variety of other computing devices. The deployment need not be direct. For example, the server 108 can be configured to produce a deployment package for transmission to the client device 104 and later deployment to the detection device 116.

Following completion of block 330, the performance of method 300 enters the third phase 303, in which the inference model data described above is employed to recognize gestures from motion data captured by one or more motion sensors. In the discussion below, the recognition of gestures is performed by the server 108, based on motion data captured by the client device 104. However, as noted earlier, the recognition of gestures can be performed at other devices as well, including either or both of the client device 104 and the detection device 116.

Specifically, at block 335, the server 108 is configured to obtain the inference model data mentioned above. In the present example, block 335 involves simply retrieving the inference model data from the memory 254. In other embodiments, for example in which gesture recognition is performed by the client device 104, obtaining the inference model data may follow block 330, and involve the receipt of the inference model data at the client device 104 from the server 108 (e.g. via the network 112). At block 340, the client device 104 (or any other motion sensor-equipped device) is configured to collect motion data. In the present example, the client device 104 is also configured to transmit the motion data to the server 108 for processing. As will be apparent from the discussion above, however, in other embodiments the client device 104 can also be configured to process the motion data locally. The motion data collected at block 340 in the present example includes IMU data (i.e. accelerometer, gyroscope and magnetometer streams), but as will be apparent to those skilled in the art, other forms of motion data may also be collected for gesture recognition.

At block 345, the server 108 is configured to receive motion data (in this case, from the client device 104) and to preprocess the motion data. The preprocessing of the motion data serves to prepare the motion data for feature extraction and gesture recognition. A variety of preprocessing functions other than, or in addition to, those discussed herein may also occur to those skilled in the art. Further; in some embodiments the client device 104 may perform some or all of the preprocessing at block 340.

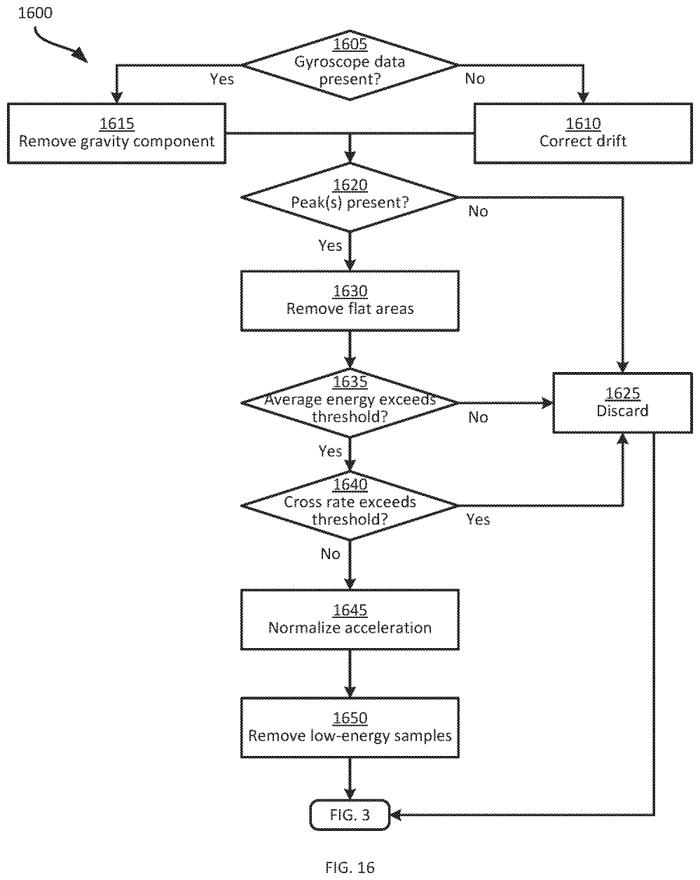

Turning to FIG. 16, a method 1600 of preprocessing motion data is illustrated, which in the present example is performed at the server 108. Prior to initiating the performance of the method 1600, the server 108 can be configured to select a subset of the received motion data potentially corresponding to a gesture. That is, the server 108 can be configured to detect start and stop points within the motion data; and to discard any motion data outside the start and stop points. The detection of a gesture's boundaries (i.e. start and stop points in the stream of motion data) can be performed, for example, by determining the standard deviation of the signal (e.g. of the acceleration values defined in the signal) for a predefined window (e.g. 0.2 seconds). This standard deviation is referred to as the base standard deviation. A sequence of standard deviations can then be generated; for adjacent windows (e.g. sliding the window along the data stream by half the window's width; e.g. 0.1 seconds). When the ratio of the standard deviation for a given window to the base standard deviation exceeds a start threshold (or when this condition is met for at least a threshold number of consecutive windows); that window indicates the start of a gesture. Likewise, a subsequent window or series of windows in which the ratio of standard deviation to base standard deviation is smaller than a stop threshold, that window indicates the end of the gesture. Subsequent preprocessing activities may be carried out only for the motion data between the start and stop points.

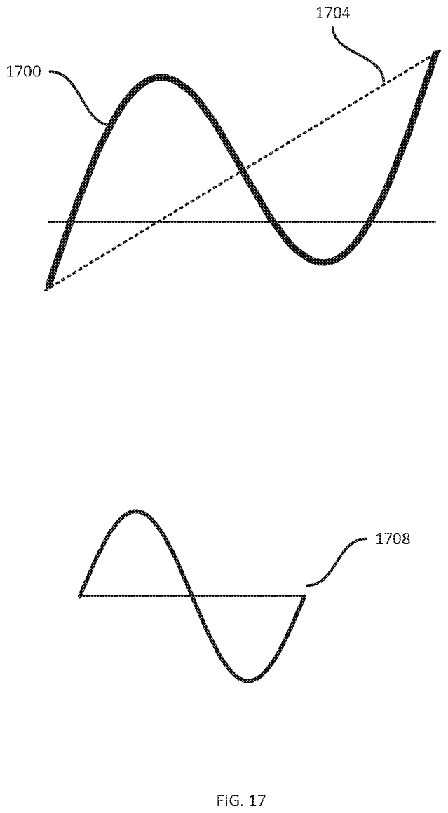

At block 1605, the server 108 is configured to determine whether the received motion data includes gyroscope and magnetometer data. When the determination at block 1605 is negative, indicating that the motion data includes only accelerometer data, the server 108 proceeds to block 1610. At block 1610, the server 108 is configured to correct drift in the accelerometer data. Turning to FIG. 17, raw accelerometer data 1700 is illustrated in which the measurements drift upwards (the drift is exaggerated for illustrative purposes). The server 108 can be configured to generate an offset line 1704 by connecting the start and end points (as detected above), and to then apply the opposite of the values defined by the offset line 1704 to the motion data, to produce corrected motion data 1708. In other examples, rather than a straight offset line, the server 108 can be configured to select a series of points along the accelerometer signal and generate an offset function from those points for application to the signal.

Returning to FIG. 16, when the determination at block 1605 is affirmative, the server 108 is configured to generate and remove a gravity component from the accelerometer data at block 1615. The gravity component is determined from the accelerometer and gyroscope data via the application of a Madgwick filter, a Mahony filter or other suitable gravity detection operation, as will occur to those skilled in the art. For example, the above-mentioned mechanisms may be employed, optionally in combination with magnetometer data, to determine an angular orientation of the device. The output of the determination of angular orientation includes a gravity component, which can be extracted for use at block 1615. The resulting vector of gravity acceleration values is then subtracted from the acceleration values in the data received from the client device 104.

At block 1620, the server 108 is configured to determine whether the motion data contains any peaks (i.e. at least one non-zero positive and at least one non-zero negative value) in each dimension. When the determination at block 1620 is negative, the data is discarded at block 1625, and the server 108 returns to FIG. 3 to await further motion data. When the determination at block 1620 is affirmative, the performance of method 1600 proceeds to block 1630. At block 1630, the server 108 is configured to identify and remove flat areas in the accelerometer data adjacent to the beginning and end boundaries of the gesture as detected above. Flat areas are those with accelerations below a threshold, or with deviations from a mean that are below a threshold (the mean need not be close to zero, however). The acceleration for any flat areas identified is set to zero.

At block 1635, the server 108 is configured to determine whether the average energy per sample in the motion data (i.e. the accelerometer data, in this example) exceeds a threshold. The average energy per sample can be determined by summing the squares of all accelerations in the signal and dividing the sum by the number of samples. If the resulting per-sample energy is below a threshold, the data is discarded at block 1625. When the determination at block 1635 is affirmative, however, the server 108 proceeds to block 1640 to determine whether a zero cross rate of the accelerometer data exceeds a threshold. The zero cross rate is the rate over time at which the accelerometer data cross the zero axis (i.e. transitions between positive and negative accelerations). A high zero cross rate may indicate motion activity as a result of high-frequency shaking of the client device 104 (e.g. during travel in a vehicle) rather than as a result of a deliberate gesture. Therefore, when the cross rate exceeds the threshold, the data is discarded at block 1625.

When the determination at block 1640 is negative, at block 1645 the server 108 is configured to normalize the acceleration values as discussed above in connection with block 1515. Finally, at block 1650, the server 108 is configured to remove low-energy samples from the acceleration data. Specifically, any sample with an acceleration (or a squared acceleration) below a threshold is set to zero. As will now be apparent, the operations at blocks 1630 and 1650 may set different measurements to zero. In particular, the removal of flat areas may set regions with low variability to zero (whether or not the acceleration is high), but not regions with high variability and low acceleration.

Following the performance of block 1650, the server 108 is configured to return to FIG. 3. At block 350, the server 108 is configured to extract features from the preprocessed motion data (specifically, each dimension of the accelerometer data). Feature extraction is performed as discussed above in connection with the method 1500. The extracted features (e.g. two time-domain and two frequency-domain feature vectors for each dimension) are the classified via execution of the inference model defined by the inference model data. The inference model generates as output at least one gesture identifier (i.e. the above-mentioned labels, such as the gesture names) and a confidence level or probability indicating the likelihood that the motion data received at block 345 corresponds to the identified gesture. The output may include such a probability for each gesture for which the inference model was trained, ranked by probability.

The identifier of the classified gesture can be sent by the server 108 to the client device 104. The client device 104, in turn, can be configured to present an indication of the classified gesture on the display 212 (e.g. along with a graphical rendering of the gesture and the confidence value mentioned above). The client device 104 can also maintain, in the memory 204, a mapping of gestures to actions, and can therefore initiate one of the actions that corresponds to the classified gesture. The actions can include executing a further application, executing a command within an application, altering a power state of the client device 104, and the like. In some embodiments, a sequence of gestures (e.g. the “M” discussed earlier, followed by the “O” discussed earlier) can be defined as corresponding to a given action, rather than a single gesture.

Variations to the above systems and methods are contemplated. For example, in some embodiments an additional client device may be employed to access the repository 266 for the definition of gestures and deployment of inference model data. More specifically, a plurality of client devices (including the client device 104) can be employed to access the repository 266 via shared account credentials (e.g. a login and password or other authentication data). The client device 104 can both initiate gesture definition, and be a target for deployment, for example to test newly defined gestures. Another client device, such as a laptop computer, desktop computer or the like (lacking a motion sensor) may be employed to define gestures but not to test gestures. The other client device (rather than the client device 104) may instead receive the above-mentioned data package for deployment to other devices, such as a set of detection devices 116.

In further embodiments, as mentioned earlier, the functionality described above as being implemented by the server 108 can be implemented instead by one or more of the client device 104 and the detection device 116. For example, the client device 104 can perform blocks 310-330 of the method 300, rather than the server 108. In further examples, a detection device 116 can perform blocks 340-355, without involvement by the client device 104 or the server 108. For example, at block 330 the server 108 or the client device 104 can be configured to deploy the inference model to the detection device 116, enabling the detection device 116 to independently perform gesture recognition. In still further embodiments, the detection device 116 may rely on the server 108 or the client device 104 for gesture recognition, as the client device 104 relies on the server 108 in the illustrated embodiment of FIG. 3.

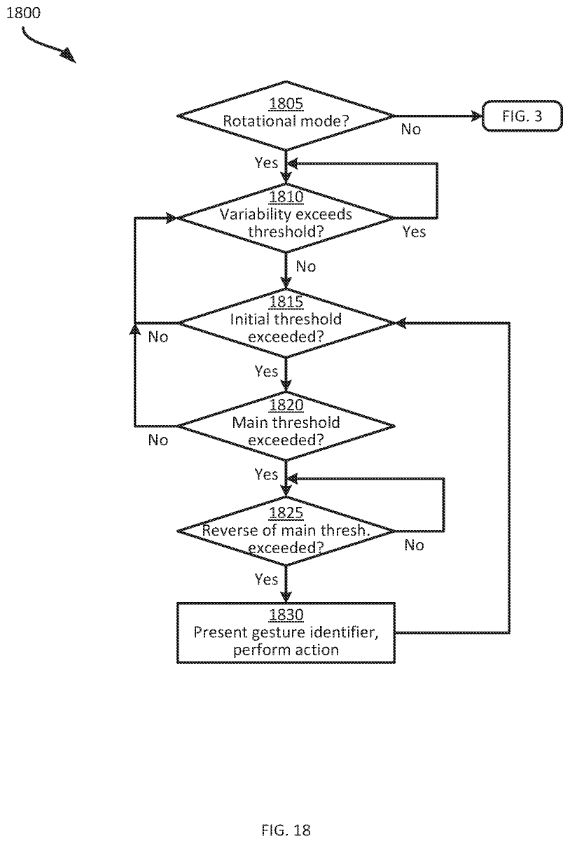

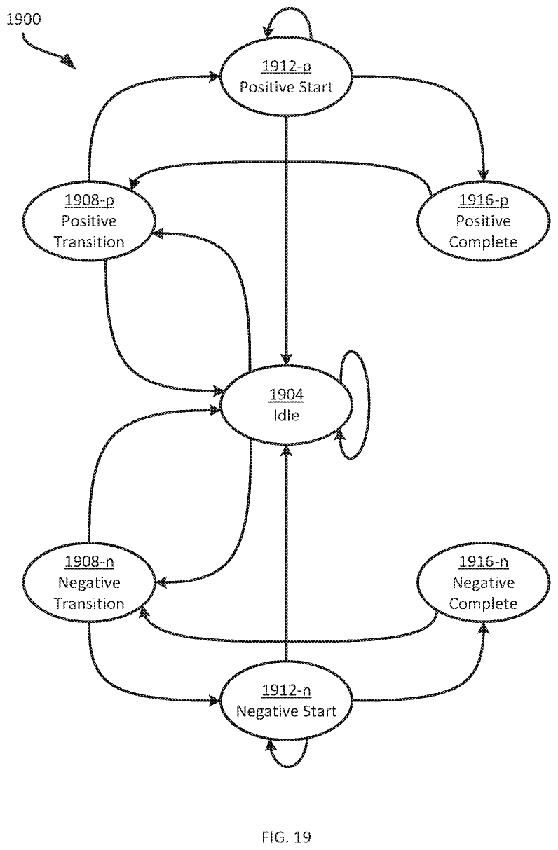

In further embodiments, the system 100 can enable the detection of additional types of gestures. For example, the system 100 can enable the detection of rotational gestures, in which the moving device (e.g. the client device 104 or the detection device 116) rotates about one or more axes travelling through the housing of the device as opposed to moving through space as described above. Turning to FIG. 18, a method 1800 of rotational gesture recognition is illustrated. The method 1800 is preferably performed by the client device 104 or the detection device 116 (or more generally, by a computing device having a local motion sensor). In other embodiments, however, the method 1800 can also be performed by the server 108, responsive to receipt of motion data as described above in connection with block 345. It is contemplated that several instances of the method 1800 are performed in parallel. Specifically, two instances (configured to detect positive or negative rotation) of the method 1800 are performed for each of three axes of rotation. Thus, via six parallel performances of the method 1800, the client device 104 is configured to detect any of six rotational gestures (e.g. positive and negative pitch, positive and negative roll, and positive and negative yaw). The method 1800 will be described in conjunction with the state diagram 1900 of FIG. 19. The state diagram 1900 illustrates corresponding states for positive and negative rotations, denoted by the suffix “-p” and “-n”, and may referred to below generically (i.e. without the suffixes).

At block 1805, the client device 104 is configured to determine whether to activate a rotational gesture recognition mode, or a movement gesture recognition mode (corresponding to the gesture recognition functionality described above in connection with FIG. 3). The determination at block 1805 can be based on, for example, whether motion data collected by a gyroscope indicates angular motion exceeding a predefined threshold. In other examples, the determination at block 1805 includes determining whether an explicit command to activate or deactivate the rotational recognition mode has been received (e.g. via the input assembly 208). When the determination at block 1805 is negative, gesture recognition is performed as described above (via inference model data), and rotational gesture recognition is disabled. When the determination at block 1805 is affirmative, however, performance of the method 1800 proceeds to block 1810. Following an affirmative determination at block 1805, the inference-based gesture recognition functionality may be disabled.

At block 1810, the client device 104 is configured to enter an idle state 1904, to determine whether a variability in collected angular movement data (e.g. collected via a gyroscope) exceeds a threshold. For example, high-frequency variations in the rotation of the client device 104 may be indicative of unintentional movement (e.g. as a result of travel in a moving vehicle or the like). The client device 104 therefore remains in the idle state 1904, and continues monitoring collected gyroscopic data.

Throughout the performance of the method 1800, assessments of angular movement (e.g. against thresholds) include the repeated determination (at any suitable frequency, e.g. 10 Hz) of a current angular orientation of the client device 104, to track changes in angular orientation over time. Angular orientation is determined, for example, by providing accelerometer data, gyroscope data, and optionally magnetometer data, to a filtering operation such as those mentioned above, to generate a quaternion representation of the device's angular position. From the quaternion representation, a rotation matrix can be extracted and a set of Euler angles can be derived from the rotation matrix. For example, the Euler angles can represent roll, pitch and yaw (e.g. angles relative to a gravitational frame of reference).

As will be apparent to those skilled in the art, Euler angles may be vulnerable to gimbal lock under certain conditions (i.e. the loss of one degree of freedom, e.g. the loss of the ability to express all three of roll, pitch and yaw). To mitigate gimbal lock, the client device 104 is configured to determine whether each of two Euler angles (e.g. roll and pitch) are below about 45 degrees. When the determination is affirmative (i.e. roll and pitch are sufficiently small), the Euler angles generated as set out above are employed. When, however, the two angles evaluated are not both below about 45 degrees, the client device 104 is instead configured to determine a difference (for each axis of rotation) between the current rotation matrix and the previous rotation matrix, and to apply the difference to the previous Euler angles.

When the determination at block 1810 is negative, the client device 104 is configured to determine at block 1815 whether an initial angular threshold has been exceeded. That is, over a predefined time period (e.g. 0.5 seconds), the client device 104 is configured to determine whether a change in angle (for the relevant axis, in either a positive or negative direction) exceeds a predefined initial threshold. The threshold is preferably between zero and ten degrees (or zero and negative ten degrees, for detecting negative rotational gestures), although it will be understood that other thresholds may also be employed. When the determination at block 1815 is negative, the client device 104 returns to block 1810 (i.e. remains in the idle state 1904).

When the determination at block 1815 is affirmative, indicating the potential beginning of a rotational gesture, the client device 104 proceeds to block 1820, which corresponds to a transitional state 1908 (i.e. 1908-n or 1908-p, dependent on the direction of the rotation) between the idle state 1904 of blocks 1810-1815 and the subsequent confirmed gesture recognition states. At block 1820, the client device 104 is configured to determine whether the change in angle over a predetermined time period indicated by gyroscopic data exceeds a main threshold. The main threshold is predefined as a threshold indicating a deliberate rotational gesture. For example, the main threshold can be between 60 and 90 degrees (though other main thresholds can also be employed). When the determination at block 1820 is negative, the client device 104 returns to block 1810 (i.e. to the idle state 1904). When the determination at block 1820 is affirmative, a rotational gesture is assumed to have been initiated, and the client device 104 proceeds to block 1825. That is, the client device 104 proceeds from the transitional state 1908 to the corresponding rotational start state 1912-n or 1912-p.

At block 1825 (i.e. in the start state 1912), the client device 104 is configured to determine whether the angle of rotation of the device, in a time period since the affirmative determination at block 1820, has exceeded the reverse of the main threshold. Thus, for a positive rotation, following a rotation exceeding 70 degrees at block 1820, the client device 104 is configured to determine at block 1825 whether a further rotation of −70 degrees has been detected, indicating that the client device 104 has been returned substantially to a starting position. When the determination at block 1825 is negative, the client device 104 continues to monitor the gyroscopic data, and repeats block 1825 (i.e. remains in the start state 1912). In other examples, following expiry of a timeout period, the rotational gesture recognition can be aborted and the performance of the method 1800 can return to block 1810 (the idle state 1904). In further embodiments, an additional performance of block 1810 can follow a negative determination at block 1825, with block 1825 being repeated only if variability in the angle of rotation remains sufficiently low (i.e. below the above-mentioned variability threshold).

When the determination at block 1825 is affirmative, indicating completion of the rotational gesture, the client device 104 proceeds to block 1830, at which the recognized rotational gesture is presented (e.g. an indication of the axis and direction of rotation is presented on the display 212), and if applicable, one or more actions mapped to the recognized gesture are initiated (as discussed above in connection with block 355). An affirmative determination at block 1825 corresponds to a transition from the state 1912 to a rotational completion state 1916-p or 1916-n as shown in FIG. 19.

Following the performance of block 1830, the client device 104 can be configured to return to block 1815 (i.e. the corresponding transition state 1908) to monitor for a subsequent rotational gesture. In some embodiments, prior to returning to block 1815, the client device 104 is configured to monitor the gyroscopic data for rotation in the same direction as the detected gesture, which indicates that the client device 104 has stabilized following the return rotation detected at block 1825.

Still further variations to the above systems and methods are contemplated. For example, the inference model discussed above may be deployed for use with sensors other than accelerometers or IMU assemblies. For instance, a detection device employing a touch sensor rather than an accelerometer may employ the same inference model by modifying the feature extraction process to derive velocity and acceleration features from the displacement-type touch data. Similar adaptations apply to other sensing modalities, including imaging sensors, ultrasonic sensors, and the like.

The scope of the claims should not be limited by the embodiments set forth in the above examples, but should be given the broadest interpretation consistent with the description as a whole.

1. A method of gesture detection in a controller, comprising:
storing, in a memory connected with the controller, inference model data defining inference model parameters for a plurality of gestures;
obtaining, at the controller, motion sensor data;
extracting an inference feature from the motion sensor data;
selecting, based on the inference feature and the inference model data, a detected gesture from the plurality of gestures; and
presenting the detected gesture.

2. The method of claim 1, further comprising:
storing, in the memory, respective actions associated with the plurality of gestures;
wherein presenting the detected gesture comprises retrieving a selected one of the actions corresponding to the detected gesture, and executing the selected action at the controller.

3. The method of claim 1, wherein presenting the detected gesture comprises rendering an indication of the detected gesture on a display connected to the controller.

4. The method of claim 1, wherein obtaining the motion sensor data comprises receiving the motion sensor data from a motion sensor connected to the controller.

5. The method of claim 1, wherein the inference feature is at least one of a time-domain feature and a frequency-domain feature.

6. The method of claim 5, wherein the inference feature includes at least one of a vector of velocities and a vector of accelerations.

7. The method of claim 1, wherein selecting the detected gesture comprises:
extracting a feature from the reconstructed motion data; and
executing a classifier based on the feature and the classification model.

8. The method of claim 7, wherein the feature includes at least one of a time-domain feature and a frequency-domain feature.

9. The method of claim 7, wherein the reconstructed motion data defines motion along a first axis and a second axis over a time interval having a start time and an end time; and
wherein the feature indicates a difference in idle periods between the first and second axes, adjacent to at least one of the start time and the end time.

10. A method of initializing gesture classification, comprising:
obtaining initial motion data defining a gesture, the initial motion data having an initial first axial component and an initial second axial component;
generating synthetic motion data by:
generating an adjusted first axial component;
generating an adjusted second axial component; and
generating a plurality of combinations from the initial first and second axial components, and the adjusted first and second axial components;
labelling each of the plurality of combinations with an identifier of the gesture; and
providing the plurality of combinations to an inference model for determination of inference model parameters corresponding to the gesture.

11. The method of claim 10, wherein generating the synthetic motion data further comprises generating the adjust first and second axial components by applying an offset to each of the initial first and second axial components.

12. The method of claim 10, wherein generating the synthetic motion data further comprises at least one of:
(i) at least one of appending and prepending a pause to the initial motion data; and
(ii) at least one of appending and prepending additional motion data to the initial motion data.

13. The method of claim 10, wherein providing the plurality of combinations to the classifier comprises extracting a feature from each of the combinations.

14. The method of claim 13, wherein the feature includes at least one of a time-domain feature and a frequency-domain feature.

15. The method of claim 14, wherein the time-domain feature includes at least one of a vector of velocities and a vector of accelerations.

16. The method of claim 10, wherein obtaining the initial motion data comprises:
obtaining, for each of a plurality of axes of motion, a sequence of motion indicators defining respective displacements along the corresponding axis;
for each motion indicator, generating a time period corresponding to the motion indicator; and
generating respective portions of the initial motion data based on the time periods.

17. The method of claim 16, further comprising, prior to generating the respective portions of the initial motion data:
assigning the motion indicators to clusters representing continuous movements within the gesture;
within each cluster, for each adjacent pair of motion indicators, determining whether to generate a merged portion of the initial motion data.

18. The method of claim 17, wherein determining whether to generate a merged portion is based on a comparison of the directions of the adjacent pair of motion indicators.

19. The method of claim 17, wherein assigning the motion indicators to clusters includes determining whether each of the motion indicators includes an interruption marker, and defining boundaries between clusters as the motion indicators including interruption markers.

20. A method of generating data representing a gesture, comprising:
receiving a graphical representation at a controller from an input device, the graphical representation defining a continuous trace in at least a first dimension and a second dimension;
generating a first sequence of motion indicators corresponding to the first dimension, and a second sequence of motion indicators corresponding to the second dimension, each motion indicator containing a displacement in the corresponding dimension; and
storing the first and second sequences of motion indicators in a memory.

21. The method of claim 20, further comprising:
prior to generating the first and second sequences of motion indicators, generating an updated graphical representation by selecting a subset of samples from the graphical representation; and
rendering the updated graphical representation on a display.

22. The method of claim 20, wherein each motion indicator further contains an interruption marker indicating whether the corresponding motion segment is terminated by a pause.

23. The method of claim 20, wherein the displacements contained in the motion indicators are relative to one another.

24. The method of claim 21, wherein selecting the subset of samples comprises:
for each of a plurality of adjacent pairs of samples in the input data, determining whether the adjacent pairs of samples indicate a change in direction exceeding a threshold.
